(19) United States
(12) Patent Application Publication
(10) Pub. No.: US 2019/0262841 A1
(43) Pub. Date: Aug. 29, 2019

(54) SAND SEPARATION SYSTEM

(71) Applicant: Certified Pressure Testing LLC, Marietta, OH (US)

(72) Inventors: Banchao SHU, Katy, TX (US); Oluwatosin A. OYELAKIN, Brooklyn, NY (US); Priyanka SHAHI, Houston, TX (US); Isaac SNYDER, Marietta, OH (US); Jeevan DAHAL, Houston, TX (US)

(73) Assignee: Certified Pressure Testing LLC, Marietta, OH (US)

(21) Appl. No.: 16/287,745

(22) Filed: Feb. 27, 2019

Related U.S. Application Data
(60) Provisional application No. 62/635,900, filed on Feb. 27, 2018.

(51) Int. Cl. B03B 5/34; B03B 9/02

(52) U.S. Cl. CPC B03B 5/34; C10G 1/045; B03B 9/02

(57) ABSTRACT

A sand separation device for use with wellhead flow, the sand separation device comprising:

a housing having a cylinder cone body configured for receiving a fluid mixture including oil, water, gas, and sand; a cyclonic insert arranged within the cylinder cone body; and a tangential inlet configured to redistribute the flow of the fluid mixture and allow for substantially laminar flow of the fluid mixture as it enters the housing and begins separation.

### FIELD OF THE INVENTION

The present disclosure relates to the removal or separation of sand from the wellhead flow or production stream at oil and gas production facilities.

### BACKGROUND OF THE INVENTION

The production of sand in the wellhead flow or production stream from conventional and unconventional wells is a common problem facing surface processing facilities, production equipment, and testing equipment for oil and gas wells. Unconsolidated reservoirs, high water production rates, or the failure of gravel packs underneath the surface can result in high sand production levels. Sand produced during this process may have a diameter ranging from 25-200 microns. Without proper treatment, the sand can build up in components of surface processing facilities and cause erosion or other damage to these components. For example, sand can build up in 2-phase or 3-phase separators, plugging pipes or causing erosion of control chokes and valves. As a result, the chokes, valves, and separators need repair and clean up frequently, otherwise equipment failure and operation problems may occur.

Traditional sand separators may apply gravity to separate the sand from multiphase fluid coming from the wellbore. These systems may have a relatively larger footprint and relatively low treatment efficiency. Contrary to the shortcomings highlighted by the traditional sand separator, the present system has a competitive edge in terms of size and efficiency of treatment. Cyclonic separators use centrifugal force for removing sand from water pumped from wells. Generally, the mode of its operation is to direct the multiphase flow into a cyclonic cylindrical vessel so that the multiphase flow assumes a swirling flow and causes the heavier sand particles to move outwardly against the wall of the vessel. The sand eventually gravitates downwardly and settles to the bottom of the vessel while gas and liquid leave through the top. Wellhead sand separator systems may apply a pressure-driven cyclonic unit process and, therefore require a controlled pressure drop to be applied across the cyclone liners to cause the flow to occur.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

This present system, in one or more embodiments, relates to sand separation from the wellhead multiphase flow. In particular, the present system includes a treatment process for the removal of sand and other solids from the production stream, which may include gas, oil, and water in addition to solids. The wellhead cyclonic sand separator may be connected after the wellhead and before the choke manifold. The separator may, thus, provide the protection to many, if not all, portions of the downstream equipment.

The present wellhead sand separation system, in one or more embodiments, includes an improved cyclone to protect downstream equipment, which improves operations of solid-handling systems at onshore or offshore locations. Cyclone devices separate two or more phases based on their weights and separate gas-liquid-solid components in a variety of applications. A cyclone utilizes the potential energy in the form of pressure of the transport fluid to produce rotating kinetic energy, or vortex flow, by forcing the flow to change flow direction using a particularly shaped device. The method and system may be particularly suitable for the separation of solid debris from multi-component fluids produced by an oil or gas well at wellhead flow pressure. Aggregated solids collecting above a choked apex may cause premature erosive failure in the cone section of the cyclonic component. A high-velocity spinning fluidized bed of solids may exist above the apex choke point. This concentrated rotating fluidized bed may erode the middle section of the cone quickly and may erode the cone section until the wall was breached. To solve the erosion problem, the present system may include a cyclonic insert in the cyclonic housing. When the cyclonic insert becomes worn, it may be replaced with a new cyclonic insert, which allows the cyclonic housing to have a more extended life.

The present system includes a novel arrangement of elements, which enables the sand, initially separated by the turbulent swirling action in the separator compartment, to flow easily by gravity into a quiet settling or accumulator compartment. This maintains the fluid in the accumulator compartment in its stable state, despite its proximity to the separator compartment.

The present system, in one or more embodiments, includes a static device, a tangential inlet, a cylinder-cone body, a combined free-forced vortex flow pattern, and a classifying operation. Gas, oil, water, and sand may enter the sand separator cyclone at system pressure via a tangential inlet. Vortex flow may be generated by the tangential inlet, the fluid flow being forced to follow a downward path by spirally wound bulkheads, or with slightly downwardly directed tangential admission. The multiphase sand separator operates efficiently in multiphase flow from a 100% gas to 100% liquid.

Unlike conventional separators, the separation system of the present invention has a higher throughput-to-size ratio. For a given flow rate, the separation system of the present invention may have the smallest footprint and weight of any technology, which is an advantage in onshore, offshore and subsea systems. The static system makes the cyclonic device unaffected by facility motion. The system of the present invention may, in some embodiments, be compact in size and may have higher sand removal efficiency than conventional separators.

In one or more embodiments, the system for separating entrained sand from gas, oil, water, and sand mixtures may comprise a cylindrical separator with an inlet nozzle positioned on one side of the cylindrical separator, a top outlet of the cylindrical separator forming the vortex finder for liquid and gas, and a bottom outlet of the cylindrical separator for a sand slurry. The top outlet may be centrally positioned. The inlet nozzle may be positioned tangentially on the one side of the separator. In one or more embodiments, the inlet nozzle may have a shape that gradually changes from a circular shape to a rectangular shape. This can may reduce the turbulence caused by the flow hitting the vortex finder wall and improve the sand separation efficiency. In one or more embodiments, the inlet nozzle may be positioned relative to the cylindrical separator in a tangential direction and may be positioned above the bottom outlet. In one or more embodiments, the inlet nozzle may be positioned relative to the cylindrical separator in a tangential direction about a conical portion of the cylindrical separator. In some embodiments, a cyclonic shaped insert may be attached to the inside of the housing wall and may taper concentrically downward with the tank. In some embodiments, the cyclonic shaped insert may have a truncated end opening at its lower end. In some embodiments, there may be a partition that forms a conical separator compartment above the end opening and a storage accumulator compartment below the end opening.

In some embodiments of the invention, the sand separator housing, a first sand accumulator, and a second sand accumulator may be connected to one another with a Y-shaped connection. The Y-shaped connection between the sand separator housing and the two sand accumulators may allow sand to drop down easier and reduce clogging as compared to 90 degree connection. In some embodiments, using at least two accumulators in parallel may enable continuous operations of the sand separator, particular with 1-2% of sand by weight, and with high sand levels up to 10% over a short period.

In some embodiments of the invention, the system may comprise a control system that allows for automated control of pressure and an automated sand discharge system. In additional embodiments, the control system may have cloud data storage with real-time communication of wellhead sand separation information.

In at least one embodiment, the system comprises sand separation device, comprising: a housing having a cylinder cone body configured for receiving a fluid mixture including oil, water, gas, and sand and further configured for routing the fluid mixture to a plurality of accumulators; a cyclonic insert arranged within the cylinder cone body; and a tangential inlet having a circular cross-section and transitioning to a rectangular cross-section, the inlet configured to redistribute the flow of the fluid mixture and allow for substantially laminar flow of the fluid mixture as it enters the housing and begins separation. In some embodiments, the tangential inlet has a circular cross-section and transitioning to a rectangular cross-section. In some embodiments, the tangential inlet is positioned relative to the cyclonic insert at an angle relative to an axis perpendicular to a longitudinal axis of the cyclonic insert. The angle may be between about two degrees and about twenty degrees. In one embodiment, the angle is about ten degrees. In some embodiments, the cyclonic insert has a sidewall with an opening and the tangential inlet is arranged within the opening. In some embodiments, the housing is further configured for routing the fluid mixture to a plurality of accumulators. A first accumulator and a second accumulator may be connected to the housing with a Y-shaped connection. Each accumulator may comprise a tank and a plurality of valves. In some embodiments, the device further comprises a control unit for selectively operating at least one of the valves of the accumulator. In some embodiments, the accumulator may have at least one sensor. The at least one sensor may be a sand level sensor. In some embodiments, the device may further comprise a control unit for receiving data from the at least one sensor.

One or more methods for separating sand from a fluid mixture may be provided. In some embodiments, the method comprises passing the fluid mixture from an inlet pipe through an inlet nozzle to a cyclonic insert; applying a centrifugal force from the inlet nozzle to redistribute the fluid mixture within the cyclonic insert; separating the fluid mixture into a gaseous mixture and a sand mixture within the cyclonic insert; passing the sand mixture to at least one accumulator. In some embodiments, the gaseous mixture exits the cyclonic insert through an opening at a top end of the cyclonic insert. In some embodiments, the sand mixture exits the cyclonic insert through an opening at a bottom end of the cyclonic insert. In at least one embodiment, an inlet nozzle comprises: a first end configured to engage with the inlet pipe, the first end having an opening with a circular cross-section; a second end configured to engage with the cyclonic insert, the second end having an opening with a rectangular cross-section; and a transitional body between the first end and the second end.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the principal and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a schematic diagram of the separation system of the present disclosure, according to one or more embodiments.

FIG. 2 is a front view of the cyclonic insert of the present disclosure, according to one or more embodiments.

FIG. 3 shows a top view of the cyclonic insert of FIG. 2.

FIG. 4 shows a perspective view of the inlet nozzle of the present disclosure, according to one or more embodiments

FIG. 5 shows a top view of the inlet nozzle of FIG. 4.

FIG. 6 is a piping and instrumentation diagram of the separation system of the present disclosure, according to one or more embodiments.

FIG. 7 is a control block diagram for a pressure control system for the separation system of the present disclosure, according to one or more embodiments.

FIG. 8 is a control block diagram for the accumulator system of the separation system of the present disclosure, according to one or more embodiments.

FIG. 9 is a data flow diagram for a separation control system of the present disclosure, according to one or more embodiments.

### DETAILED DESCRIPTION

The present disclosure relates to systems and methods for improved sand separation from the wellhead flow. In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion. For the convenience of description, the following embodiment references the cyclonic separator in an upright position with the feed inlet at the side of the separator and sand outlets at the top and bottom of the apparatus. Still other arrangements may be provided or are contemplated by this invention.

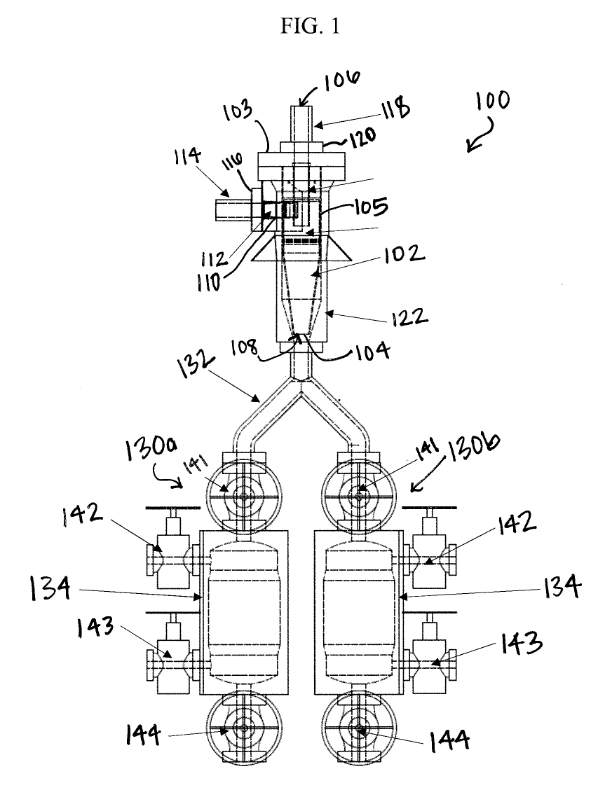

FIG. 1 shows an embodiment of the sand separation system 100 according to the present invention. The sand separation system 100 comprises a cyclonic insert 102 having a top 103, a bottom 104, and a sidewall 105 extending between the top 103 and the bottom 104. The cyclonic insert 102 may have an opening 106 in the top 103 configured to allow liquid and gas of the wellhead stream to exit the system. The cyclonic insert may have an opening 108 in the bottom 104 configured to allow sand and other particulates to be removed from the wellhead stream and exit the cyclonic insert 102. The cyclonic insert 102 may have an opening 108 in the bottom 104 configured to allow sand and other particulates to be removed from the wellhead stream and exit the cyclonic insert 102. In at least one embodiment, the opening 106 and the opening 108 may be axially aligned relative to a longitudinal axis of the cyclonic insert. The cyclonic insert may have an opening 110 in the sidewall 105 configured to receive an inlet nozzle 112. The opening 110 may be configured so that the inlet nozzle 112 may be positioned tangentially relative to the cyclonic insert 102. In at least one embodiment, the inlet nozzle 112 is connected to an inlet pipe 114, which may be connected to the wellhead to provide the wellhead stream to the sand separation system. In at least one embodiment, the inlet pipe 114 may comprise a flange 116 that can be positioned against the sidewall 105 of the cyclonic insert. In some embodiments, the system may further comprise an outlet pipe 118 in communication with the opening 106 and configured to allow liquid and gas of the wellhead stream to exit the system. The outlet pipe 118 may comprise a flange 120 that can be positioned against the top 103 of the cyclonic insert 102. In some embodiments, the system may further comprise a sand separator housing 122 for receiving any sand and other particulates that exit the opening 108 in the bottom 104 of the cyclonic insert 102. In at least one embodiment at least a portion of the cyclonic insert 102 may be positioned within the sand separator housing 122.

The wellhead flow may enter the sand separation system from the inlet pipe 114, pass through the inlet nozzle 112, to the cyclonic insert 102. Based on the position and configuration of the inlet nozzle 112, the tangential inlet may introduce centrifugal force to the wellhead flow. The heavier sand may be concentrated while swirling on the wall, and gravity may pull the sand and other particulates into the sand separator housing 122. In some embodiments, oil and water because of their properties relative to other components of the wellhead flow may fall into the sand separator housing 122 along with the sand in a sand mixture. Gas and other liquids may escape the cyclonic insert 102 by exiting through the outlet pipe 118 at the top 103 of the cyclonic insert 102.

The system of the present invention may further comprise one or more accumulators 130 connected to the cyclonic insert 102 and/or the sand separator housing 122. The accumulators 130 may collect the sand mixture (which may include oil, water, and sand) exiting from the cyclonic insert 102 through exit opening 108. In at least the embodiment shown, the system comprises a first accumulator 130a and a second accumulator 130b. The accumulators 130a and 130b are connected to at least one of the cyclonic insert 102 and the sand separator housing 122 with the Y-shaped connection 132. In at least one embodiment, the accumulator 130 comprises an accumulator tank 134 for storage and/or separation of sand from the sand mixture. Each accumulator 130 may comprise a number of valves 140. More particularly, each accumulator may have an inlet valve 141 between the Y-shaped connection 132 and the accumulator tank 134, a pressure relieve valve 142, a flush water valve 143, a sand discharge valve 144. In some embodiments, each accumulator may have one or more sensors. In at least one embodiment, each accumulator 130 may have a sand level sensor. In at least one embodiment, each accumulator 130 may have a pressure transmitter. In some embodiments, the accumulators 130 may be controlled via a control unit to determine whether the accumulator should be online or offline. Depending on which accumulator is online, the sand and liquid may pass one of the accumulator inlet valves 141 into the respective accumulator 130. In some embodiments when all of the valves 140, including inlet valve 141 are closed, sand may be concentrated, but liquid may be forced back up into the cyclonic insert and exit the cyclonic insert through the outlet pipe 118 at the top of the unit.

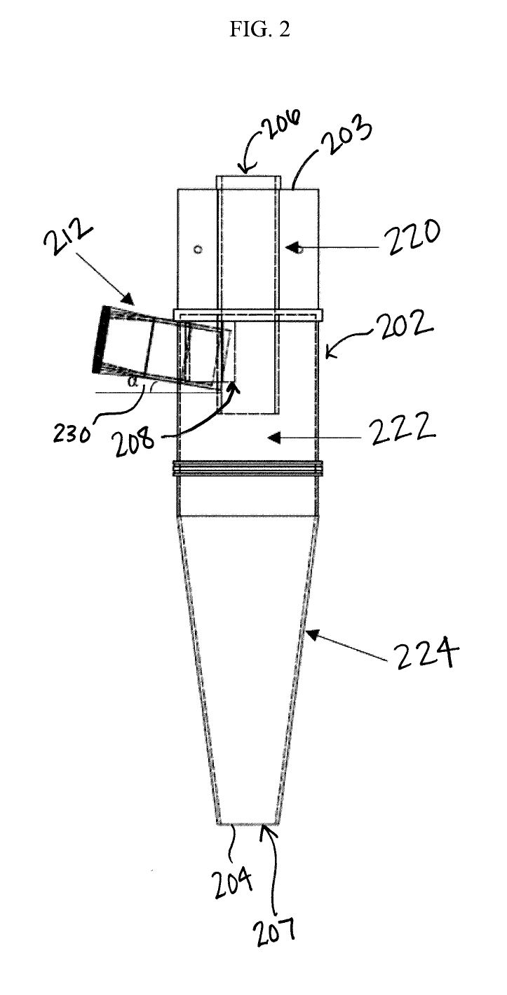

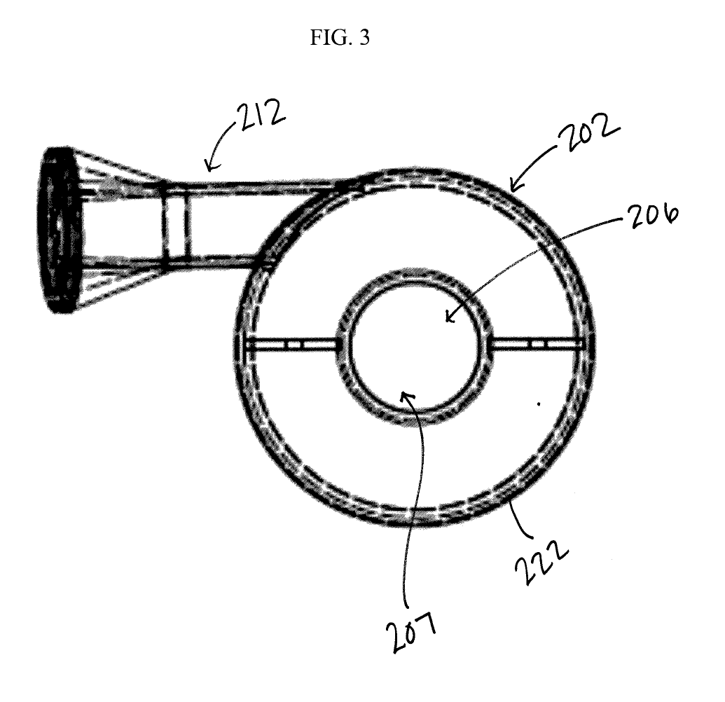

FIGS. 2-3 show one embodiment of the cyclonic insert 202 with inlet nozzle 212. The cyclonic insert 202 has a top end 203, a bottom end 204 and a side wall 205 extending from the top end 203 to the bottom end 204. The cyclonic insert has a first opening 206 at the top end 203 to allow a gaseous mixture to exit the cyclonic insert 202. The cyclonic insert 202 has a second opening 207 at the bottom end 204 to allow a sand mixture to exit the cyclonic insert 202. In at least one embodiment, the first opening 206 may be concentric with the second opening 207. In other embodiments, the second opening 207 may be offset from the first opening 206 along a longitudinal axis of the cyclonic insert 202. The cyclonic insert 202 has a third opening 208 within the side wall 205 configured to receive the inlet nozzle 212. In at least one embodiment, sealing members such as O-rings may be provided between the inlet nozzle 212 and the cyclonic insert 202 to prevent leakage of fluid from the cyclonic insert 202. The cyclonic insert 202 has a first cylindrical section 220 near the top end 203, a second cylindrical section 222 engaged with the inlet nozzle 212, and a conical section 224 extending from the second cylindrical section 222 to the second opening 207. As shown, a diameter of the conical section 224 narrows or tapers from the second cylindrical section 222 to the second opening 207. In at least one embodiment, the second cylindrical section 222 may comprise a centrally positioned vortex finder. In at least one embodiment, the cyclonic insert 202 is housed within a housing and maybe concentrically positioned within the housing. Sealing members such as O-rings may be provided between the cyclonic insert 202 and housing to prevent leakage of fluid from the cyclonic insert 202.

The position of the inlet nozzle 212 may be at an inlet angle 230 relative to an axis perpendicular to the longitudinal axis of the cyclonic insert 202. The size of the angle relates to the cyclone cut-size, and there by the cyclone collection efficiency. Increasing the inlet angle increases the cyclone cut-size and as a result, reduces cyclone collection efficiency. Increasing the inlet angle also decreases the cyclone pressure drop leading to lower pressure losses. In some embodiments, the inlet angle may range from approximately 2 degrees to approximately 20 degrees. In some embodiments, the inlet angle may range from approximately 5 degrees to approximately 15 degrees. In some embodiments, the inlet angle may range from approximately 12 degrees to approximately 18 degrees. In at least one embodiment, the inlet angle may be approximately 15 degrees. In at least one embodiment, the inlet angle may be approximately 10 degrees. Still other inlet angles may be provided within the ranges suggested or outside the ranges suggested.

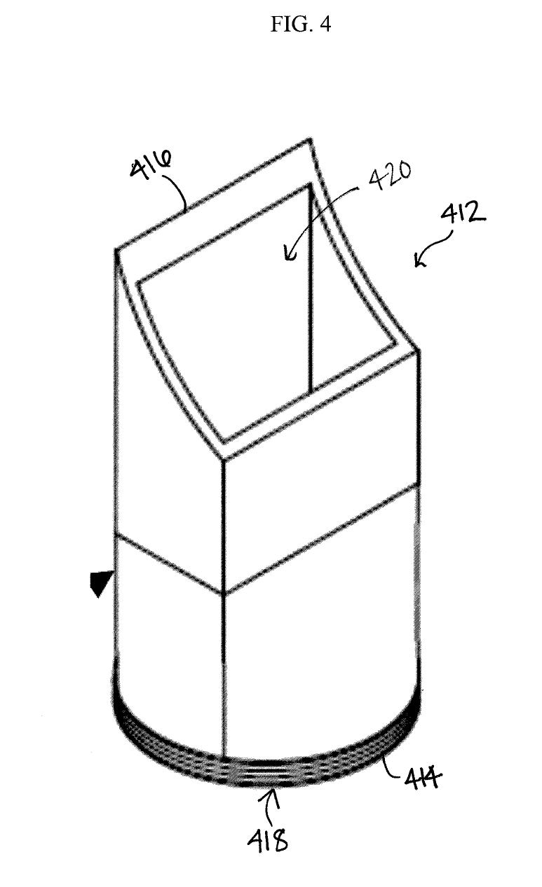

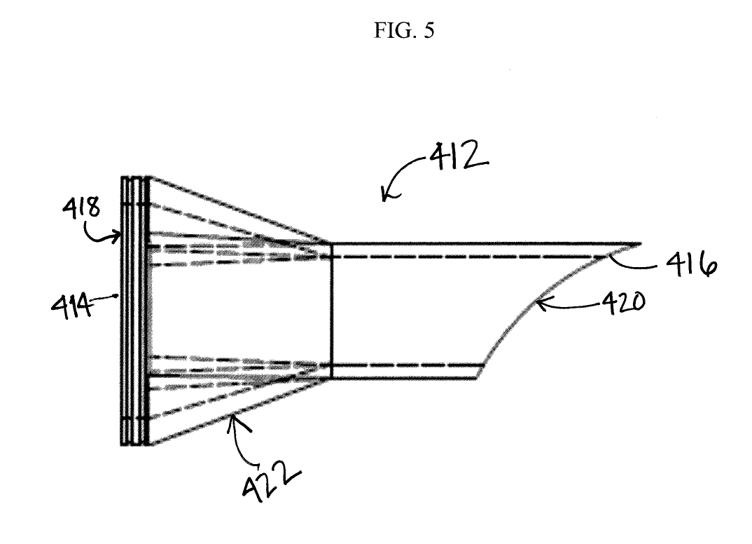

FIGS. 4-5 show one embodiment of the inlet nozzle 412 having a first end 414 configured to engage with an inlet pipe and a second end 416 configured to engage with the cyclonic insert. The first end 414 may have an opening 418 with a generally circular cross-section. The second end 416 may have an opening 420 with a generally rectangular cross-section. The inlet nozzle 412 comprises a transitional body that gradually changes shape from the circular cross-section to the rectangular cross-section from the first end 414 to the second end 416. In some embodiments, the area of the opening 418 at the first end 414 may be larger than the area of the opening 420 at the second end 416. The narrowed rectangular opening 420 may reduce the turbulence in the cyclonic insert, reduce the corrosion, and improve sand separation efficiency to more than 99%. In some embodiments, the inlet nozzle 412 may have a conical section 422 near the first end 414.

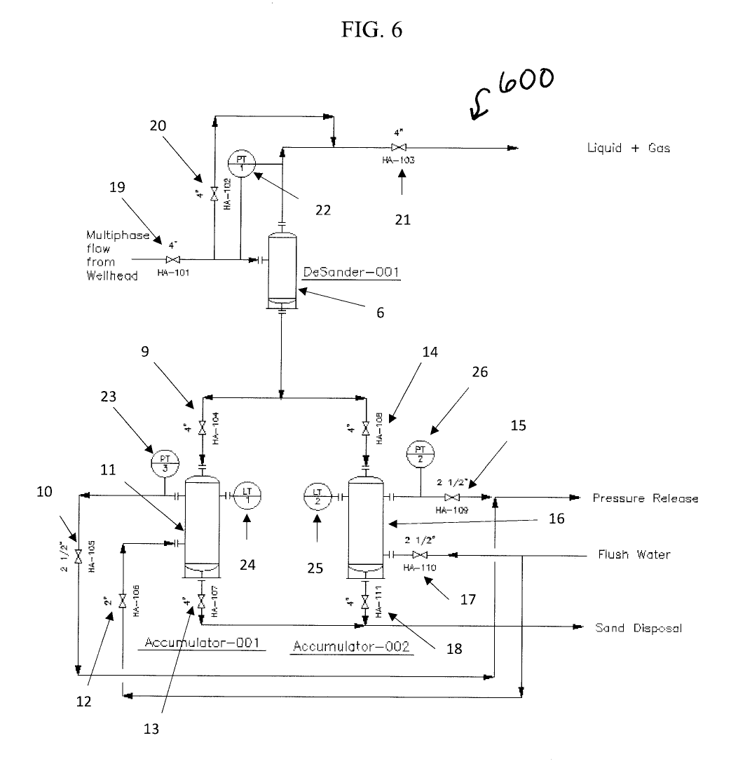

FIG. 6 is a schematic diagram of at least one embodiment of piping and instrumentation for the sand separation system 600. The sand separator region may include a main inlet for the fluid mixture from the wellhead, a gas and liquid outlet on the top, and an outlet for the sand mixture to enter at least one of the accumulators. A differential pressure indicator may be provided between a first inlet valve between the wellhead and the inlet nozzle and a second valve at the exit for the gaseous mixture to measure the pressure drop. While operating, the inlet valve may remain open, while a bypass valve between the first inlet valve and the inlet nozzle may be closed. During an emergency, the bypass valve may be opened to bypass the inlet nozzle, and, when closed, the bypass valve acts opposite to the inlet valve. In some embodiments, the second valve at the exit for the gaseous mixture may be used as a pressure control valve on the gas and liquid outlet on the top of the sand separator device.

In one or more embodiments, one of the accumulators may be online for collecting sand from the cyclonic insert, while the other accumulator is offline performing sand discharge based on the condition of the sand level. In at least one embodiment, the left accumulator may be online first. An inlet valve between the cyclonic insert and the left accumulator may remain open if the sand level is below the desired level in the online accumulator. The inlet valve for the right accumulator, which is offline, may remain closed while the accumulator is offline. Each accumulator may have a sand level sensor to determine whether the performance of sand discharge is required. When the sand level sensor detects a desired sand level in the online, left accumulator, the system may close the inlet valve for the left accumulator, putting the left accumulator into an offline mode. The system may open the inlet valve for the right accumulator, putting the right accumulator into an online mode. The left accumulator, in the offline mode, may be ready for sand discharge while the right accumulator, now online, may be collecting sand from the cyclonic insert. A depressurizing valve of the left accumulator may be open and may remain open until the pressure within the offline, left accumulator reaches atmospheric pressure which may be detected through a pressure transducer. After discharge of the left accumulator is completed, the depressurizing valve of the left accumulator may be closed and the sand discharge valve at the end of the left accumulator may be opened. Flushing water may be supplied to the left accumulator through the flushing water valve by a pump. Sand in the left accumulator may be flushed out of the left accumulator through the sand discharge valve by the pressure from flushing water. The sand discharge valve may be closed once the desired low level of sand is detected in left accumulator. The flushing valve may remain open until the liquid level of fresh water reaches the desired level in left accumulator. Although this description is written with respect to the use and discharging of the left accumulator, the description herein may likewise apply to the use and discharging of the right accumulator.

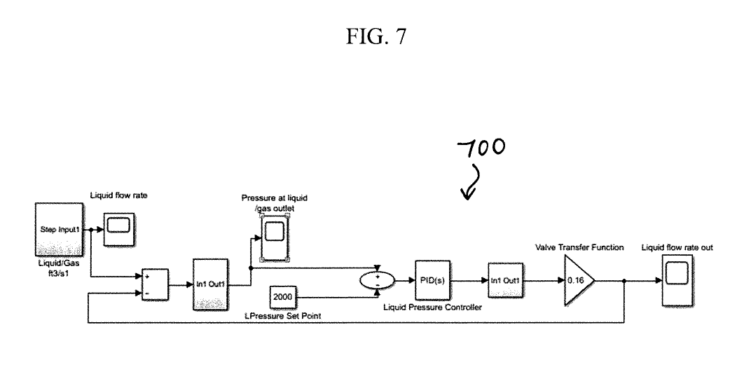

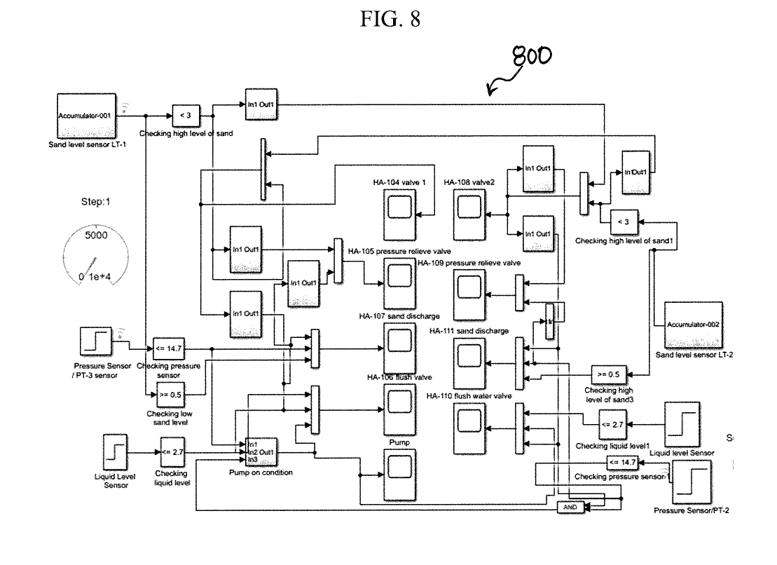

FIG. 7 shows the pressure control valve system 700 utilizing a controller to maintain the desired pressure of the system. FIG. 8 shows a control system 800 in the accumulator region. The sand discharging process in one of the left accumulator and right accumulator may begin once a level of the sand full condition is met by observation of the sand level sensor of each of the left accumulator and the right accumulator.

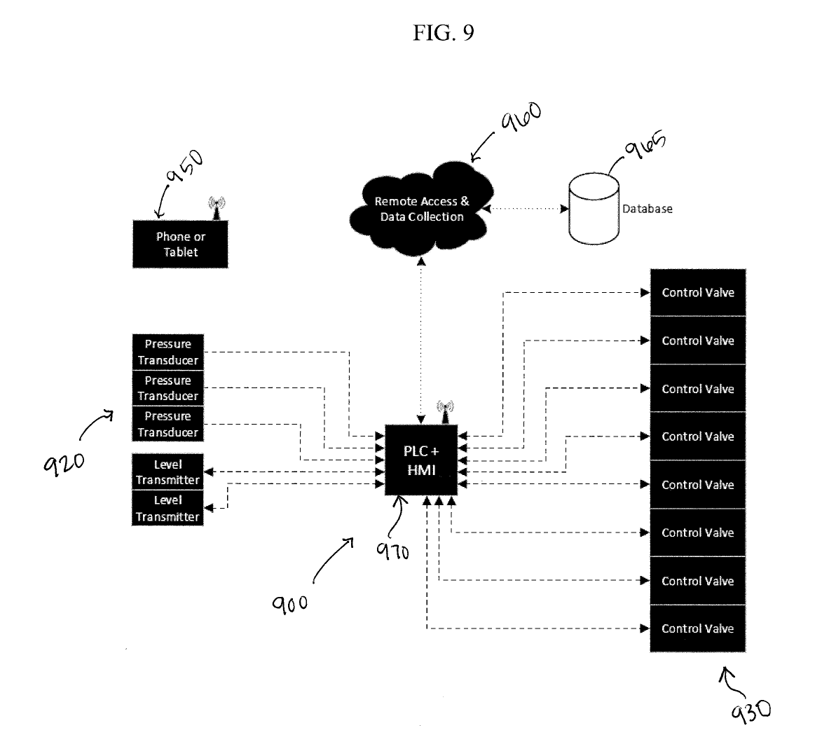

In at least one embodiment, the system may further comprise a control unit such as a programmable logic controller that may be in electronic communication with one or more sensors and valves of the system to measure and transmit pressure, valve position, valve control, sand level, and any other related process information. Any or all of the sensors and valves of the system may send information to the control unit using at least one of an analog signal, digital signal, or pulse signal. These signals may be received and processed by the control unit, which in turn may be used in mathematical formulas, process measurements, prediction & estimation models, and data collection. The control unit may be used to operate control valves which control the direction of fluid flow within the sand separation system. In at least one embodiment, the control unit may have an interface that may display data to a user. In some embodiments, the interface may display data to the user in real time for remote monitoring of the system. A user may review information through the interface and may submit manual control changes to adjust the sand separation system. The control unit may have a touchscreen Human Machine Interface (HMI). The status of the sand separation system may be accessed remotely by a phone or tablet using an app associated with the control unit. Alternatively, the sand separator can be accessed via the web several ways. For example, the sand separator may be accessed with a direct connection to the device using the provided “Remote Operator” software, which essentially duplicates the control unit, providing full functionality. The control unit can also act as a web server, providing access via a web browser. With the proper URL and login credentials, the control unit can be accessed with full functionality. In some embodiments, the control unit may be connected to a database to retrieve and store data in real time. providing real-time data recording to a dedicated server. FIG. 9 shows a data flow diagram for a control system 900 including a control unit 970 of the system according to one or more embodiments of the invention. The control unit 970 may communicate with a number of sensors shown generally as 920 and a number of control valves shown generally 930. The control unit 970 may communicate remotely with a device 950 such as a phone, tablet, or other computing device. In some embodiments, the control unit 970 may communicate with a remote access and data collection module 960 to retrieve and store data from a database 965.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a minicomputer, mainframe computer, personal computer (e.g., desktop or laptop), tablet computer, embedded computer, mobile device (e.g., personal digital assistant (PDA) or smart phone) or other hand-held computing device, server (e.g., blade server or rack server), a network storage device, or any other suitable device or combination of devices and may vary in size, shape, performance, functionality, and price. A system may include volatile memory (e.g., random access memory (RAM)), one or more processing resources such as a central processing unit (CPU) or hardware or software control logic, ROM, and/or other types of nonvolatile memory (e.g., EPROM, EEPROM, etc.). A basic input/output system (BIOS) can be stored in the non-volatile memory (e.g., ROM), and may include basic routines facilitating communication of data and signals between components within the system. The volatile memory may additionally include a high-speed RAM, such as static RAM for caching data.

Additional components of a system may include one or more disk drives or one or more mass storage devices, one or more network ports for communicating with external devices as well as various input and output (I/O) devices, such as digital and analog general purpose I/O, a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, a storage subsystem, or any combination of storage devices. A storage interface may be provided for interfacing with mass storage devices, for example, a storage subsystem. The storage interface may include any suitable interface technology, such as EIDE, ATA, SATA, and IEEE 1394. A system may include what is referred to as a user interface for interacting with the system, which may generally include a display, mouse or other cursor control device, keyboard, button, touchpad, touch screen, stylus, remote control (such as an infrared remote control), microphone, camera, video recorder, gesture systems (e.g., eye movement, head movement, etc.), speaker, LED, light, joystick, game pad, switch, buzzer, bell, and/or other user input/output device for communicating with one or more users or for entering information into the system. These and other devices for interacting with the system may be connected to the system through I/O device interface(s) via a system bus, but can be connected by other interfaces such as a parallel port, IEEE 1394 serial port, a game port, a USB port, an IR interface, etc. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices.

A system may also include one or more buses operable to transmit communications between the various hardware components. A system bus may be any of several types of bus structure that can further interconnect, for example, to a memory bus (with or without a memory controller) and/or a peripheral bus (e.g., PCI, PCIe, AGP, LPC, I2C, SPI, USB, etc.) using any of a variety of commercially available bus architectures.

One or more programs or applications, such as a web browser and/or other executable applications, may be stored in one or more of the system data storage devices. Generally, programs may include routines, methods, data structures, other software components, etc., that perform particular tasks or implement particular abstract data types. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. A user may interact with the system, programs, and data stored thereon or accessible thereto using any one or more of the input and output devices described above.

A system of the present disclosure can operate in a networked environment using logical connections via a wired and/or wireless communications subsystem to one or more networks and/or other computers. Other computers can include, but are not limited to, workstations, servers, routers, personal computers, microprocessor-based entertainment appliances, peer devices, or other common network nodes, and may generally include many or all of the elements described above. Logical connections may include wired and/or wireless connectivity to a local area network (LAN), a wide area network (WAN), hotspot, a global communications network, such as the Internet, and so on. The system may be operable to communicate with wired and/or wireless devices or other processing entities using, for example, radio technologies, such as the IEEE 802.xx family of standards, and includes at least Wi-Fi (wireless fidelity), WiMax, and Bluetooth wireless technologies. Communications can be made via a predefined structure as with a conventional network or via an ad hoc communication between at least two devices.

Hardware and software components of the present disclosure, as discussed herein, may be integral portions of a single computer, server, controller, or message sign, or may be connected parts of a computer network. The hardware and software components may be located within a single location or, in other embodiments, portions of the hardware and software components may be divided among a plurality of locations and connected directly or through a global computer information network, such as the Internet. Accordingly, aspects of the various embodiments of the present disclosure can be practiced in distributed computing environments where certain tasks are performed by remote processing devices that are linked through a communications network. In such a distributed computing environment, program modules may be located in local and/or remote storage and/or memory systems.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart or block diagram may illustrate a method as comprising sequential steps or a process as having a particular order of operations, many of the steps or operations in the flowchart(s) or block diagram(s) illustrated herein can be performed in parallel or concurrently, and the flowchart(s) or block diagram(s) should be read in the context of the various embodiments of the present disclosure. In addition, the order of the method steps or process operations illustrated in a flowchart or block diagram may be rearranged for some embodiments. Similarly, a method or process illustrated in a flow chart or block diagram could have additional steps or operations not included therein or fewer steps or operations than those shown. Moreover, a method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Still further, the figures depict preferred embodiments for purposes of illustration only. One skilled in the art will readily recognize from the discussion herein that alternative embodiments of the structures and methods illustrated herein may be employed without departing from the principles described herein.

Upon reading this disclosure, those skilled in the art will appreciate still additional alternative structural and functional designs for the customized urn. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

While the systems and methods described herein have been described in reference to some exemplary embodiments, these embodiments are not limiting and are not necessarily exclusive of each other, and it is contemplated that particular features of various embodiments may be omitted or combined for use with features of other embodiments while remaining within the scope of the invention. Any feature of any embodiment described herein may be used in any embodiment and with any features of any other embodiment.

What is claimed is:

1. A sand separation device, comprising:
a housing having a cylinder cone body configured for receiving a fluid mixture including oil, water, gas, and sand;
a cyclonic insert arranged within the cylinder cone body;
and a tangential inlet configured to redistribute the flow of the fluid mixture and allow for substantially laminar flow of the fluid mixture as it enters the housing and begins separation.

2. The sand separation device of claim 1, wherein the tangential inlet has a circular cross-section and transitioning to a rectangular cross-section.

3. The sand separation device of claim 1, wherein the tangential inlet is positioned relative to the cyclonic insert at an angle relative to an axis perpendicular to a longitudinal axis of the cyclonic insert.

4. The sand separation device of claim 3, wherein the angle is between about two degrees and about twenty degrees.

5. The sand separation device of claim 4, wherein the angle is about ten degrees.

6. The sand separation device of claim 1, wherein the cyclonic insert has a sidewall with an opening and the tangential inlet is arranged within the opening.

7. The sand separation device of claim 1, wherein the housing is further configured for routing the fluid mixture to a plurality of accumulators.

8. The sand separation device of claim 7, wherein a first accumulator and a second accumulator are connected to the housing with a Y-shaped connection.

9. The sand separation device of claim 7, wherein each accumulator comprises a tank and a plurality of valves.

10. The sand separation device of claim 9, further comprising a control unit for selectively operating at least one of the valves of the accumulator.

11. The sand separation device of claim 9, wherein each accumulator further comprises at least one sensor.

12. The sand separation device of claim 11, wherein the at least one sensor is a sand level sensor.

13. The sand separation device of claim 11, further comprising a control unit for receiving data from the at least one sensor.

15. A method for separating sand from a fluid mixture including oil water, gas, and sand, the method comprising:
passing the fluid mixture from an inlet pipe through an inlet nozzle to a cyclonic insert;
applying a centrifugal force from the inlet nozzle to redistribute the fluid mixture within the cyclonic insert;
separating the fluid mixture into a gaseous mixture and a sand mixture within the cyclonic insert;
passing the sand mixture to at least one accumulator.

16. The method of claim 15, wherein the gaseous mixture exits the cyclonic insert through an opening at a top end of the cyclonic insert.

17. The method of claim 15, wherein the sand mixture exits the cyclonic insert through an opening at a bottom end of the cyclonic insert.

18. The method of claim 15, wherein the inlet nozzle comprises:
a first end configured to engage with the inlet pipe, the first end having an opening with a circular cross-section;
a second end configured to engage with the cyclonic insert, the second end having an opening with a rectangular cross-section; and
a transitional body between the first end and the second end.

19. The method of claim 15, further comprising:
selectively operating at least one of the accumulators based on data received by a control unit from at least one sensor.

20. An inlet nozzle for a sand separation device, the inlet nozzle comprising:
a first end configured to engage with an inlet pipe for transferring a fluid mixture including oil, water, gas, and sand, the first end having an opening with a circular cross-section;
a second end configured to engage with a cyclonic insert, the second end having an opening with a rectangular cross-section; and
a transitional body between the first end and the second end.
